(19) United States
(12) Patent Application Publication
(10) Pub. No.: US 2022/0062926 A1
(43) Pub. Date: Mar. 3, 2022

(54) VARIABLE-RATE SPRAYING NOZZLE DEVICE AND SPRAYING DRONE

(71) Applicant: SHANDONG UNIVERSITY OF TECHNOLOGY, Shandong (CN)

(72) Inventors: Lili Yi, Shandong (CN); Yubin Lan, Shandong (CN); Fanxia Kong, Shandong (CN); Boyuan Zhang, Shandong (CN)

(73) Assignee: SHANDONG UNIVERSITY OF TECHNOLOGY, Shandong (CN)

(21) Appl. No.: 17/414,099

(22) PCT Filed: Jan. 8, 2021
(86) PCT No.: PCT/CN2021/070774

§ 371 Date: Jun. 15, 2021

(30) Foreign Application Priority Data
Nov. 12, 2019 (CN) 201911103613.7

(51) Int. Cl. B05B 3/10; B64C 39/02; B64D 1/18; A01M 7/00

(52) U.S. Cl. CPC B05B 3/1021; B64C 39/024; B64C 2201/12; A01M 7/0014; B05B 3/1035; B64D 1/18

(57) ABSTRACT

A variable-rate spraying nozzle device includes a chemical supply assembly and an atomization spray assembly for atomizing and spraying a chemical solution. The atomization spray assembly includes spray housings arranged sequentially from top to bottom, chemical solution channels are provided between two adjacent spray housings, and the spray housings are assembled together to form an inverted tapered exterior structure; spray holes are densely and circumferentially provided in each spray housing; spray housings are connected with an atomization power mechanism including atomization rotation shafts and a power mechanism including motors and transmission mechanisms for connecting main spindles of the motors with the atomization rotation shafts correspondingly; the atomization rotation shafts in the atomization power mechanism corresponding to the spray housings are coaxially disposed; the motors in the atomization power mechanism are connected with a speed control module.

### TECHNICAL FIELD

The present disclosure relates to the field of spraying drone's spraying technologies, and more particularly, to a variable-rate spraying nozzle device and a spraying drone.

### BACKGROUND ART

At present, the plant protection device and spraying technology are relatively backward. A utilization rate of agricultural chemicals is less than 30%, a loss of agricultural chemicals is up to 60%-70% or more, and an uneven distribution of agricultural chemicals is up to 46.6%. The utilization rate of agricultural chemicals is low, resulting in that a large amount of agricultural chemicals needs to be sprayed to achieve an anticipated spraying effect, which undoubtedly causes a large amount of waste of agricultural chemicals and environmental contamination. Therefore, an improvement of spraying technology is very important for improving the effective utilization of agricultural chemicals.

The spraying of agricultural chemicals with the same amount in an entire area is often performed by a conventional spraying drone. That is, the amount of the agricultural chemicals is constant during the spraying of the spraying drone, which therefore cannot be adapted to local conditions. This leads to problems such as low effective utilization of agricultural chemicals and environmental contamination, which seriously endangers a sustainable development of agriculture. In order to achieve an object of “precision agriculture”, each piece of arable land is invested with the most reasonable resource and positioned in the most precise operation to obtain the greatest economic and environmental benefits. According to this principle, it is necessary to propose a variable-rate nozzle device for spraying agricultural chemicals and a spraying drone.

### SUMMARY

With regard to the deficiencies existing in the prior art, the present disclosure aims to provide a variable-rate spraying nozzle device and a spraying drone. The device achieves variable-rate spraying of agricultural chemicals, saves the agricultural chemicals, and avoids environmental contamination.

The above technical object of the present disclosure is achieved by the following technical solution: a variable-rate spraying nozzle device includes a chemical supply assembly for supplying a chemical solution and an atomization spray assembly for atomizing and spraying the chemical solution. The atomization spray assembly includes a plurality of spray housings arranged in sequence from top to bottom, chemical solution channels for passing the chemical solution are provided between inner portions of adjacent two of the spray housings, and the plurality of spray housings are assembled together to form an inverted tapered exterior structure; spray holes are densely and circumferentially provided in each of the plurality of spray housings; the plurality of spray housings are connected with an atomization power mechanism comprising a plurality of atomization rotation shafts coaxially and fixedly arranged with the plurality of spray housings respectively and power mechanisms for driving the plurality of atomization rotation shafts to rotate, and the power mechanisms include motors and transmission mechanisms for connecting main spindles of the motors with the atomization rotation shafts; the plurality of atomization rotation shafts in the atomization power mechanism corresponding to the plurality of spray housings are coaxially disposed; the motors in the atomization power mechanism are connected with a speed control module.

The chemical supply assembly includes a water tank, a chemical tank, a chemical mixer, pumps and pipes, the water tank and the chemical tank are connected to the chemical mixer via the pipes and the pumps, and a chemical discharging end of the chemical mixer is connected to an uppermost one of the spray housings via the pipes.

In some embodiments, inner bottoms of the plurality of spray housings are of tapered structure, and each inner bottom is uniformly and circumferentially provided with guiding grooves extending downward from the plurality of spray holes along the inner bottom.

In some embodiments, one of the atomization rotation shafts, which is corresponding to a lowermost one of the spray housings, may be a hollow atomization rotation shaft; a liquid collecting recess may be provided at a center of the inner bottom of the lowermost one of the spray housings; the guiding grooves on the lowermost one of the spray housings may be in communication with the liquid collecting recess, an inner cavity of the hollow atomization rotation shaft may be in communication with the liquid collecting recess and may be provided with a drain pipe for discharging an excess chemical solution to outside.

In some embodiments, the chemical solution channels may be arranged in parts of the plurality of spray housings which may be connected to the plurality of atomization rotation shafts, and the chemical solution channels may be a plurality of arranged circumferentially chemical solution channels.

In some embodiments, the chemical solution channels are further arranged at areas of the plurality of spray housings at which the guiding grooves are located, and the chemical solution channels may penetrate through the plurality of spray housings from top to bottom.

In some embodiments, in the plurality of spray housings arranged from top to bottom, the plurality of atomization rotation shafts may be provided in sequence and decrease in diameter in sequence, such that one of the atomization rotation shafts, which is corresponding to a first one of the spray housings, may be coaxially arranged in one of the atomization rotation shafts corresponding to a second one of the spray housings, the first one may be positioned lower than the second one; and bearings may be provided between two adjacent atomization rotation shafts.

In some embodiments, the motors may be fixed on a motor fixing frame, and the transmission mechanisms may be gear transmission mechanisms; the gear transmission mechanisms corresponding to the plurality of spray housings may be arranged on a mounting bracket which is provided above the uppermost one of the spray housings, and the gear transmission mechanisms may be staggered in a height direction; driving gears of the gear transmission mechanisms may be connected respectively with the main spindles of the motors, and driven gears of the gear transmission mechanisms may be connected respectively with the plurality of atomization rotation shafts.

In some embodiments, the speed control module may be a motor speed control module employing a PWM control mode.

In some embodiments, the plurality of spray housings may include three spray housings that are a first spray housing, a second spray housing and a third spray housing arranged in sequence from top to bottom.

A spraying drone is further provided by the present disclosure, and the above variable-rate spraying nozzle device is arranged on the drone.

The present disclosure has the following beneficial effects compared with the prior art:

1. The present disclosure provides multi-spray housings, so the number of the working spray housings can be selected to adjust a spray amount in a macro aspect, and the spray housings each have different spraying ranges which can be selected for operation of the spray housings. The rotational speed of the motor can be controlled by the speed control module in a micro aspect to change the spray amount of each spray housing. In this way, by the combination of macro and micro adjustment methods, the precise control of the spray amount of the agricultural chemicals is achieved.

2. The variable-rate spraying nozzle device of the present disclosure is combined with high-efficiency operation advantages of the spraying drone, which can realize the variable and efficient spraying operation on field cash crops. The “air preparation” and “air spraying” of the chemicals are implemented in the present disclosure. The macro variable-rate spraying and the micro variable-rate spraying are mutually assisted each other for spraying as required, reducing the waste of agricultural chemicals, as well as contamination and destruction of the environment.

3. The variable-rate spraying operation on the field cash crops is achieved by the spraying drone of the present disclosure, so as to effectively improve the utilization rate of agricultural chemicals. The spray with two reductions (i.e., reductions of the waste of agricultural chemicals and the environmental contamination) on field crops can be readily carried out and can replace the existing variable-rate spraying mode. The anti-flight operations with variable-rate spraying are realized in a real sense from the source.

### BRIEF DESCRIPTION OF THE DRAWINGS

In order to more clearly illustrate the embodiments of the disclosure or the technical schemes in the prior art, the drawings required in the embodiments will be briefly described below. It is obvious that the drawings in the following description are only some embodiments of the disclosure, for those skilled in the art, other drawings can be obtained according to the drawings without creative work.

FIG. 1 is a front schematic view of a variable-rate spraying nozzle device according to one embodiment of the present disclosure.

FIGS. 2-4 are schematic views of an atomization spray assembly in FIG. 1, in which FIG. 2 is a front cross-sectional view, FIG. 3 is a perspective view, and FIG. 4 is a perspective view from another perspective.

FIG. 5 is a perspective view of a first spray housing.

FIG. 6 is a perspective view of a second spray housing.

FIG. 7 is a perspective view of a third spray housing.

FIGS. 8-10 are schematic views of the atomization spray assembly of the present disclosure in different working modes according to the present disclosure, in which FIG. 8 is a schematic view of the first spray housing spraying the chemical solution, FIG. 9 is a schematic view of the first spray housing and the second spray housing both spraying the chemical solution, and FIG. 10 is a schematic view of three spray housings spraying chemical solution.

### DETAILED DESCRIPTION OF THE EMBODIMENTS

The technical schemes in the embodiments of the present disclosure will be clearly and completely described below combining with the accompanying drawings in the embodiments of the present disclosure. It is obvious that the embodiments described are only a part of the embodiments of the present disclosure, rather than all the embodiments. Based on the embodiments of the present disclosure, all other embodiments, which are obtained by a person skilled in the art based on the embodiments of the present disclosure without creative work, shall fall within the protection scope of the present disclosure.

The disclosure aims to provide a variable-rate spraying nozzle device, which is used for solving the problems existing in the prior art.

In order to make the above purposes, features and advantages of the present disclosure more comprehensible, the present disclosure is further and in detail described combining with the accompanying drawings and specific embodiments thereof.

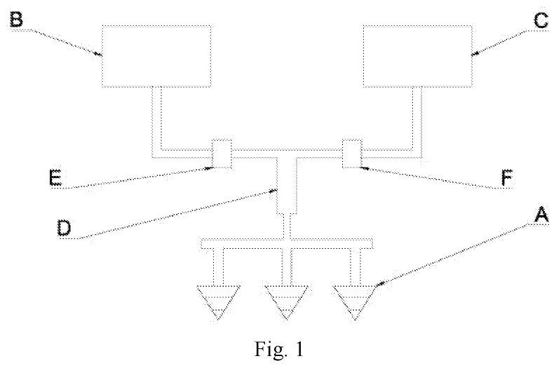

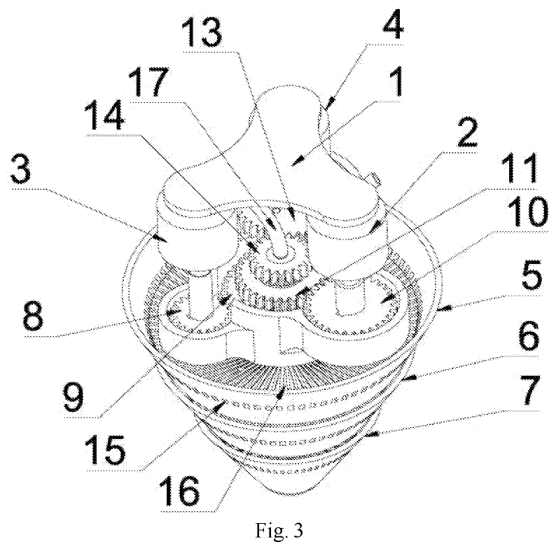

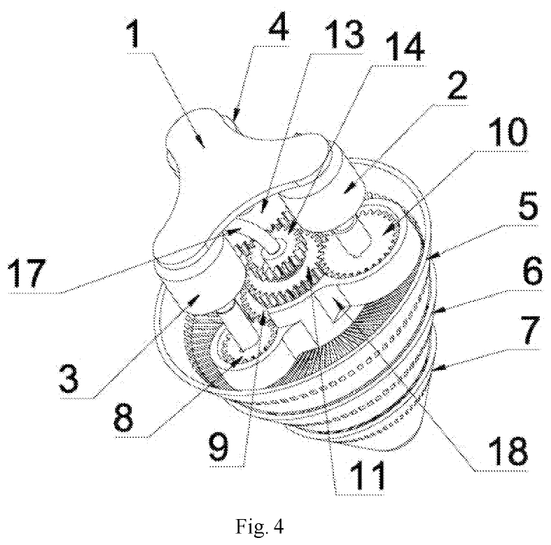

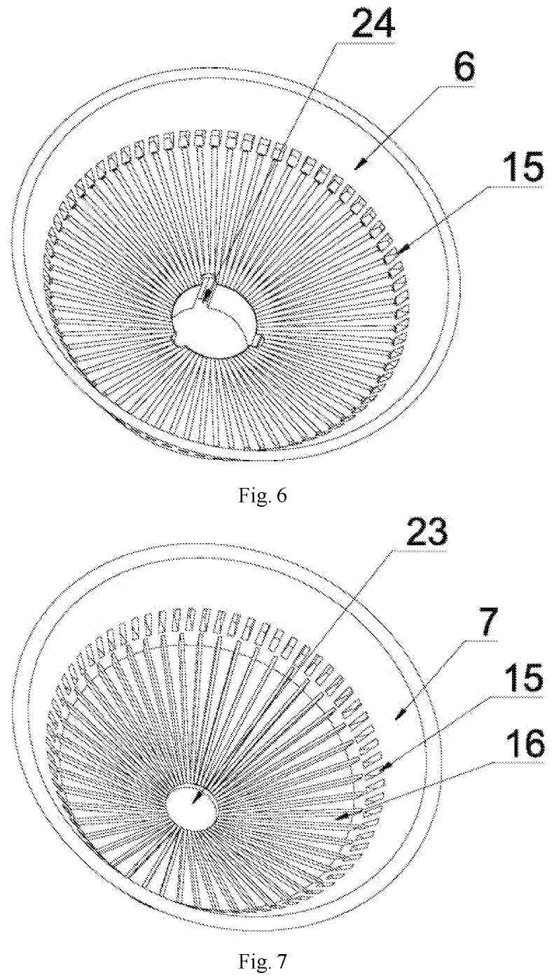

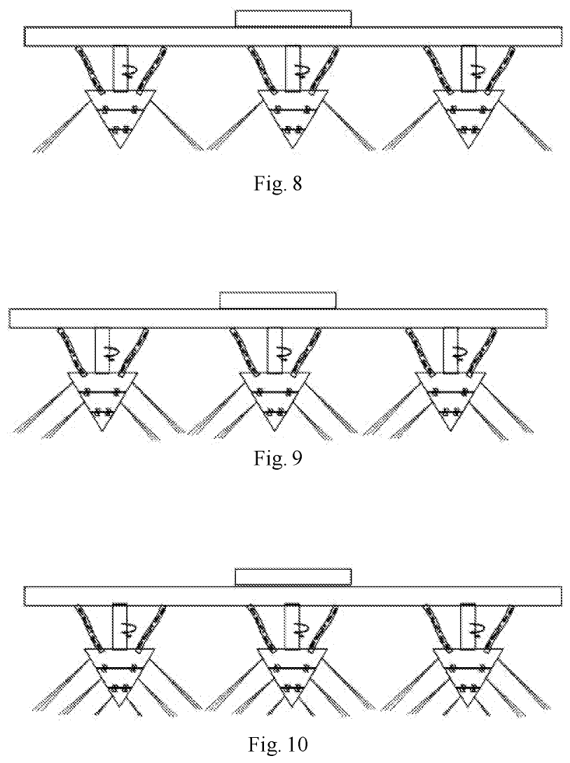

As shown in FIGS. 1-10, a variable-rate spraying nozzle device includes a chemical supply assembly for supplying a chemical solution and an atomization spray assembly A for atomizing and spraying the chemical solution.

The atomization spray assembly A includes multiple spray housings arranged in sequence from top to bottom, and chemical solution channels 24 for passing the chemical solution is provided between inner portions of two adjacent spray housings, and the multiple spray housings are assembled together to form an inverted tapered exterior structure; spray holes 15 are densely and circumferentially provided in each of the multiple spray housings; each of the multiple spray housings is connected with an atomization power mechanism. The atomization power mechanism includes multiple atomization rotation shafts coaxially and fixedly arranged with the multiple spray housings respectively, and power mechanisms for driving the multiple atomization rotation shafts to rotate. And the power mechanisms include motors and transmission mechanisms for connecting main spindles of the motors with the atomization rotation shafts; the multiple atomization rotation shafts in the atomization power mechanism corresponding to the multiple spray housings are coaxially disposed. The motors in the atomization power mechanisms are connected with a speed control module.

The chemical supply assembly includes a water tank B, a chemical tank C, a chemical mixer D (being chemical mixing tube D in this embodiment), a water supply pump E, a chemical supply pump F and pipes. The water tank B and the chemical tank C are connected to the chemical mixer via the pipe and the pump, and a chemical discharging end of the chemical mixer is connected to an uppermost one of the spray housings via the pipes 19.

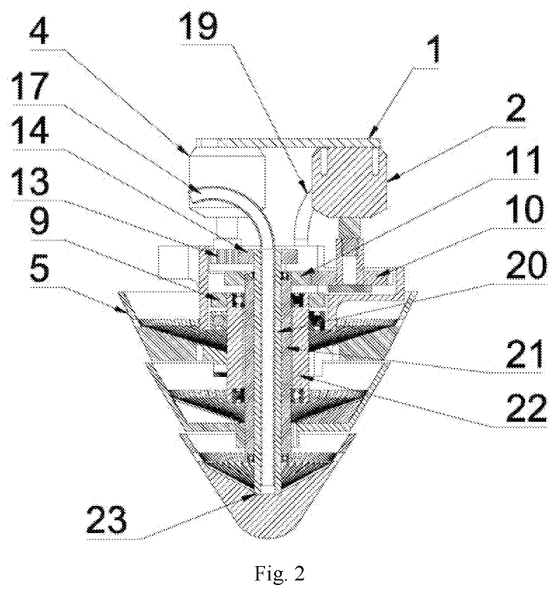

As shown in FIGS. 2-4, in this embodiment, the multiple spray housings include three spray housings that are a first spray housing 5, a second spray housing 6 and a third spray housing 7 arranged in sequence from top to bottom. The atomization rotation shafts of the atomization power mechanism are arranged correspondingly with three spray housings, and are a first atomization rotation shaft 22, a second atomization rotation shaft 21 and a third atomization rotation shaft 20, respectively.

Referring to FIGS. 2-4, inner bottoms of the three spray housings are of inverted tapered structure, and each inner bottom is uniformly and circumferentially provided with guiding grooves 16 extending downward from the multiple spray holes 15 along the inner bottom. The inner bottoms of the spray housings are configured to be the inverted tapered structure, so that chemical solution in the spray housings flows downward along the inner bottom collectively, thereby facilitating the chemical solution to flow through a corresponding chemical solution channel 24 into a lower spray housing. By an arrangement of the guiding grooves 16, the chemical solution in the spray housings can be guided by the guiding grooves 16 towards the spray holes 15 under the centrifugal action when the spraying housing is rotated by the atomization rotation shaft, so as to make the chemical solution to be threw out the spraying housing, thereby implementing the spraying of the chemical solution. The flow guiding grooves 16 can better allow the chemical solution to spray away from the spraying housings through the spray holes 15, so that a better spraying effect is obtained.

As shown in FIG. 2, the third atomization rotation shaft 20 corresponding to the third spray housing 7 is a hollow atomization rotation shaft. A liquid collecting recess 23 is provided at a center of an inner bottom of the third spray housing 7. The guiding grooves 16 on the third spray housing 7 are in communication with the liquid collecting recess 23. An inner cavity of the third atomization rotation shaft 20 is in communication with the liquid collecting recess 23 and is provided with a drain pipe 17 for discharging excess chemicals to outside. During the spraying of chemical solution, since the chemical solution flows from top to bottom through the chemical solution channels 24 in sequence into each spray housings, the chemical solution remaining in the third spray housing 7 at the lowest layer gradually increases. In this case, the remaining chemical solution that is guided into the liquid collecting recess 23 is discharged from the third spray housing 7 via the drain pipe 17, so as to prevent the chemical solution from accumulating too much in the third spray housings 7, and to prevent weight of the entire device from increasing. The discharged chemical solution is brought back to a chemical mixing box or other chemical solution recycling box for reuse. The drain pipe 17 in the present embodiment can be connected to a liquid pump, and thus the chemical solution is pumped out from the lowermost spraying housing under the action of the liquid pump. In addition, a liquid level sensor may be provided in the lowermost spray housing, and the liquid pumping operation is performed according to an actual remaining amount of the chemical solution.

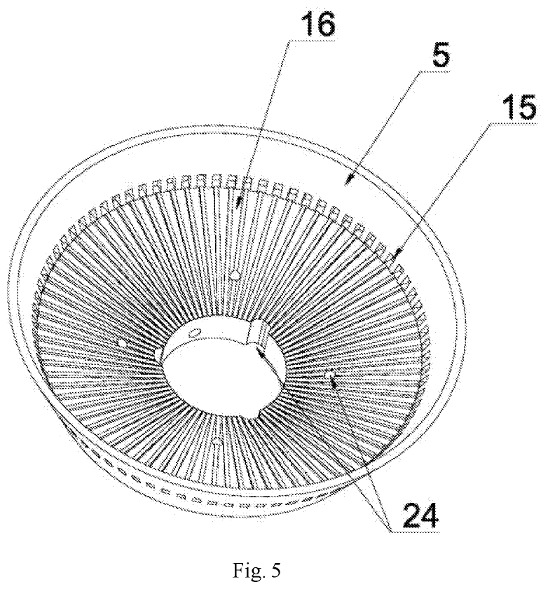

As shown in FIGS. 5-7, the chemical solution channels 24 are arranged in parts of spray housings of which are connected to atomization rotation shafts, and the chemical solution channels 24 are multiple arranged circumferentially chemical solution channels. Further, the chemical solution channels 24 are further arranged at areas of the plurality of spray housings at which the guiding grooves 16 are located, and the chemical solution channels penetrate through the spray housings from top to bottom. In the present embodiment, two groups of the chemical solution channels 24 are arranged on the first spray housing 5, in which one group of the chemical solution channels 24 is arranged in the areas at which the guiding grooves 16 are located, and the other group of the chemical solution channels 24 is arranged in a part of the first spray housing 5 which is connected to the third atomization rotation shaft 22. Only one group of the chemical solution channels 24 are arranged on the second spray housing 6, and are arranged at a part of the second spray housing 6 which is connected to the second atomization rotation shaft 21. The discharging end of the chemical mixer is connected to the first spray housing 6 via a pipe, so that more chemicals are readily stored in the first spray housing 5. By providing two groups of the chemical solution channels 24, a speed of the chemical solution flowing to the second spray housing 6 can be accelerated, thereby avoiding the chemical solution staying in the first spray housing 5 for a long time. When a level of the chemical solution in the first spray housing 5 is lower than the chemical solution channels 24 in the area at which the guiding grooves 16 are located, a flow rate of the chemical solution is returned to normal, so as to store a certain amount of chemical solution in the first spray housing 5 as much as possible. Since the inner cavity of the third housing is relatively small, it is sufficient to provide one group of chemical solution channels 24 on the second housing 6 to avoid storing too much chemical solution in the third spray housing.

As shown in FIG. 2, the multiple atomization rotation shafts, which are corresponding to the three spray housings arranged from top to bottom, are provided in sequence and decrease in diameter in sequence. And an atomization rotation shaft corresponding to the lower spray housing is coaxially arranged in an atomization rotation shaft corresponding to an upper spray housing; bearings are provided between two adjacent atomization rotation shafts. In this way, the entire atomization shafts can be made more compact, the space thereof is saved, and the corresponding spray housing can be easy to be driven to rotate. All atomization rotation shafts are arranged coaxially without interfering with each other, therefore, the design is ingenious.

As shown in FIGS. 2-4, the motors are fixed on a motor fixing frame 1, and the transmission mechanisms are gear transmission mechanisms; multiple gear transmission mechanisms corresponding to the multiple spray housings are arranged on a mounting bracket 18 which is provided above the uppermost spray housing, and the multiple gear transmission mechanisms are staggered in a height direction; driving gears of the multiple gear transmission mechanisms may be connected with the main spindles of the motors correspondingly, and driven gears of the multiple gear transmission mechanisms are connected with the multiple atomization rotation shafts respectively.

As shown in FIGS. 2-4, in this embodiment, the motors include a first motor 3, a second motor 2 and a third motor 4. The first motor 3 is connected with a first driving gear 8. The first driving gear 8 engages with a first driven gear 9 arranged on the first atomization rotation shaft 22. The second motor 2 is connected with a second driving gear 10. The second driving gear 10 engages with a second driven gear 11 arranged on the second atomization rotation shaft 21. The third motor 4 is connected with a third driving gear 13. The third driving gear 13 engages with a third driven gear 14 arranged on the third atomization rotation shaft 20.

In this embodiment, the speed control module is a motor speed control module employing a Pulse Width Modulation (PWM) control mode. The spray amount of each spray housing can be adjusted by a control mode of the PWN, thereby achieving micro adjustment of the spray amount. And by the combination of macro and micro adjustment methods, precise control of spray amount of agricultural chemicals is further achieved.

As shown in FIG. 1, a spraying drone is provided by the present embodiment, and is provided with the variable-rate spraying nozzle device. Wherein, three atomization spray assemblies A may be provided on the spraying drone simultaneously, so as to expand spraying range. The three atomization spray assemblies A are connected with the spraying drone via a carbon tube. Of course, different numbers of atomization spray assemblies A may also be provided as required.

In addition, the variable-rate spraying nozzle device of the present disclosure may be applied to a ground spraying operation device.

The working principle of the variable-rate spraying nozzle device of the present embodiment is as follows.

Water in the water tank and the chemicals in the chemical tank in the chemical supply assembly are transported to the chemical mixer by means of the pump in a setting proportion; after mixing, the chemical solution is formed and transported into the first spray housing 5, and the chemical solution in the first spray housing 5 flows downward through the chemical solution channels 24 into the second spray housing 6 and the third spray housing 7. One or more of the multiple power mechanisms can be selected to work according to requirements of the spray amount. For a single spray housing, during operation, a power of the motor is transmitted to a corresponding atomization rotation shaft via a transmission mechanism, thereby driving the spray housing to rotate. The chemical solution moves rapidly and atomizes under a rotation of the spray housing. The atomized chemical solution particles are sprayed from the spray holes 15 under the action of centrifugal force. For adjusting the spray amount, on the one hand, it can be macroscopically controlled by selecting the number of the working spraying housings. Since multiple spray housings are assembled together to form the inverted tapered structure, the spraying operation ranges of the spray housings do not interfere with each other, and the spraying radius of the upper spray housing is greater than the spraying radius of the lower spray housing, as shown in FIGS. 8-10. On the other hand, the spray amount of each spray housing can be adjusted by controlling the rotational speeds of the motors via the speed control module, thereby achieving microscopic adjustment of the spray amount. The precise control of the spray amount of the agricultural chemicals is achieved by the combination of macro and micro adjustment methods.

The principle and the implementation mode of the present disclosure are explained by using specific examples in the present specification, and the above description of the embodiments is only used to help understand the method and the core idea of the present disclosure; meanwhile, for a person skilled in the art, it may be changed in the specific embodiments and the application range according to the idea of the present disclosure. In conclusion, the contents of the description should not be construed as limitations on the disclosure.

1. A variable-rate spraying nozzle device comprising a chemical supply assembly for supplying a chemical solution and an atomization spray assembly for atomizing and spraying the chemical solution, wherein:
the atomization spray assembly comprises:
a plurality of spray housings arranged in sequence from top to bottom, the plurality of spray housings:
assembled together to form an inverted tapered exterior structure;
each with spray holes densely and circumferentially provided therein; and
each connected with an atomization power mechanism comprising a plurality of atomization rotation shafts coaxially and fixedly arranged with the plurality of spray housings respectively and power mechanisms for driving the plurality of atomization rotation shafts to rotate, and the power mechanisms comprise motors and transmission mechanisms for connecting main spindles of the motors with the atomization rotation shafts, the plurality of atomization rotation shafts in the atomization power mechanism corresponding to the plurality of spray housings are coaxially disposed and the motors in the atomization power mechanism are connected with a speed control module; and
chemical solution channels for passing the chemical solution and provided between inner portions of adjacent two of the spray housings; and
the chemical supply assembly comprises a water tank, a chemical tank, a chemical mixer, pumps, and pipes, the water tank and the chemical tank are connected to the chemical mixer via the pipes and the pumps, the chemical mixer having a chemical discharging end connected to an uppermost one of the plurality of spray housings via the pipes.

2. The variable-rate spraying nozzle device according to claim 1, wherein inner bottom of each of the plurality of spray housings is of inverted tapered structure, and each inner bottom is uniformly and circumferentially provided with guiding grooves extending downward from the plurality of spray holes along the inner bottom.

3. The variable-rate spraying nozzle device according to claim 2, wherein one of the atomization rotation shafts, which is corresponding to a lowermost one of the spray housings, is a hollow atomization rotation shaft; a liquid collecting recess is provided at a center of the inner bottom of the lowermost one of the spray housings;
the guiding grooves on the lowermost one of the spray housings are in communication with the liquid collecting recess, an inner cavity of the hollow atomization rotation shaft is in communication with the liquid collecting recess and is provided with a drain pipe for discharging an excess chemical solution to outside.

4. The variable-rate spraying nozzle device according to claim 3, wherein the chemical solution channels are arranged in parts of the plurality of spray housings which are connected to the plurality of atomization rotation shafts, and the chemical solution channels are a plurality of arranged circumferentially chemical solution channels.

5. The variable-rate spraying nozzle device according to claim 1, wherein the chemical solution channels are further arranged at areas of the plurality of spray housings at which the guiding grooves are located, and the chemical solution channels penetrate through the plurality of spray housings from top to bottom.

6. The variable-rate spraying nozzle device according to claim 3, wherein, in the plurality of spray housings arranged from top to bottom, the plurality of atomization rotation shafts are provided in sequence and decrease in diameter in sequence, such that one of the atomization rotation shafts, which is corresponding to a first one of the spray housings, is coaxially arranged in one of the atomization rotation shafts corresponding to a second one of the spray housings, the first one is positioned lower than the second one; and bearings are provided between two adjacent atomization rotation shafts.

7. The variable-rate spraying nozzle device according to claim 1, wherein the motors are fixed on a motor fixing frame, and the transmission mechanisms are gear transmission mechanisms; the gear transmission mechanisms corresponding to the plurality of spray housings are arranged on a mounting bracket which is provided above the uppermost one of the spray housings, and the gear transmission mechanisms are staggered in a height direction; driving gears of the gear transmission mechanisms are connected respectively with the main spindles of the motors, and driven gears of the gear transmission mechanisms are connected respectively with the plurality of atomization rotation shafts.

8. The variable-rate spraying nozzle device according to claim 1, wherein the speed control module is a motor speed control module employing a PWM control mode.

9. The variable-rate spraying nozzle device according to claim 1, wherein the plurality of spray housings comprise three spray housings that are a first spray housing, a second spray housing and a third spray housing arranged in sequence from top to bottom.

10. A spraying drone comprising a variable-rate spraying nozzle device arranged on the spraying drone, wherein: the variable-rate spraying nozzle device comprises a chemical supply assembly for supplying a chemical solution and an atomization spray assembly for atomizing and spraying the chemical solution, wherein:
the atomization spray assembly comprises:
a plurality of spray housings arranged in sequence from top to bottom, the plurality of spray housings:
assembled together to form an inverted tapered exterior structure;
each with spray holes densely and circumferentially provided therein; and
each connected with an atomization power mechanism comprising a plurality of atomization rotation shafts coaxially and fixedly arranged with the plurality of spray housings respectively and power mechanisms for driving the plurality of atomization rotation shafts to rotate, and the power mechanisms comprise motors and transmission mechanisms for connecting main spindles of the motors with the atomization rotation shafts, the plurality of atomization rotation shafts in the atomization power mechanism corresponding to the plurality of spray housings are coaxially disposed and the motors in the atomization power mechanism are connected with a speed control module; and
chemical solution channels for passing the chemical solution and provided between inner portions of adjacent two of the spray housings; and
the chemical supply assembly comprises a water tank, a chemical tank, a chemical mixer, pumps and pipes, the water tank and the chemical tank are connected to the chemical mixer via the pipes and the pumps, the chemical mixer having a chemical discharging end connected to an uppermost one of the plurality of spray housings via the pipes.

11. The spraying drone according to claim 10, wherein inner bottoms of the plurality of spray housings are of inverted tapered structure, and each inner bottom is uniformly and circumferentially provided with guiding grooves extending downward from the plurality of spray holes along the inner bottom.

12. The spraying drone according to claim 11, wherein one of the atomization rotation shafts, which is corresponding to a lowermost one of the spray housings, is a hollow atomization rotation shaft; a liquid collecting recess is provided at a center of the inner bottom of the lowermost one of the spray housings; the guiding grooves on the lowermost one of the spray housings are in communication with the liquid collecting recess, an inner cavity of the hollow atomization rotation shaft is in communication with the liquid collecting recess and is provided with a drain pipe for discharging an excess chemical solution to outside.

13. The spraying drone according to claim 12, wherein the chemical solution channels are arranged in parts of the plurality of spray housings which are connected to the plurality of atomization rotation shafts, and the chemical solution channels are a plurality of arranged circumferentially chemical solution channels.

14. The spraying drone according to claim 10, wherein the chemical solution channels are further arranged at areas of the plurality of spray housings at which the guiding grooves are located, and the chemical solution channels penetrate through the plurality of spray housings from top to bottom.

15. The spraying drone according to claim 12, wherein, in the plurality of spray housings arranged from top to bottom, the plurality of atomization rotation shafts are provided in sequence and decrease in diameter in sequence, such that one of the atomization rotation shafts, which is corresponding to a first one of the spray housings, is coaxially arranged in one of the atomization rotation shafts corresponding to a second one of the spray housings, the first one is positioned lower than the second one; and bearings are provided between two adjacent atomization rotation shafts.

16. The spraying drone according to claim 10, wherein the motors are fixed on a motor fixing frame, and the transmission mechanisms are gear transmission mechanisms; the gear transmission mechanisms corresponding to the plurality of spray housings are arranged on a mounting bracket which is provided above the uppermost one of the spray housings, and the gear transmission mechanisms are staggered in a height direction; driving gears of the gear transmission mechanisms are connected respectively with the main spindles of the motors, and driven gears of the gear transmission mechanisms are connected respectively with the plurality of atomization rotation shafts.

17. The spraying drone according to claim 10, wherein the speed control module is a motor speed control module employing a PWM control mode.

18. The spraying drone according to claim 10, wherein the plurality of spray housings comprise three spray housings that are a first spray housing, a second spray housing and a third spray housing arranged in sequence from top to bottom.
